(19) United States
(12) Patent Application Publication
(10) Pub. No.: US 2025/0216951 A1
(43) Pub. Date: Jul. 3, 2025

(54) DYNAMIC DIRECT USER INTERACTIONS WITH VIRTUAL ELEMENTS IN 3D ENVIRONMENTS

(71) Applicant: Apple Inc., Cupertino, CA (US)

(72) Inventors: Chase B. Lortie, San Francisco, CA (US); David J. Meyer, Mercer Island, WA (US); Bharat C. Dandu, Santa Clara, CA (US)

(21) Appl. No.: 18/952,284

(22) Filed: Nov. 19, 2024

Related U.S. Application Data
(60) Provisional application No. 63/615,588, filed on Dec. 28, 2023.

(51) Int. Cl. G06F 3/01; G02B 27/01

(52) U.S. Cl. CPC G06F 3/017; G02B 27/017; G06F 3/011

(57) ABSTRACT

Various implementations interpret user activity as user interactions with virtual elements (e.g., user interface elements) positioned within in a 3D space such as an XR environment. Some implementations enable a user to provide input using a direct input modality in which the user interacts with virtual content by virtually touching the virtual content. As examples, a user may move their finger to directly tap, pinch, swipe, or otherwise interact with a user interface (UI) element within a 3D space. Some implementations perform touch detection (e.g., detecting when a user's finger virtually makes, continues, and breaks virtual contact with a UI element in 3D space) using position and velocity information about the user.

### CROSS-REFERENCE TO RELATED APPLICATIONS

This Application claims the benefit of U.S. Provisional Application Ser. No. 63/615,588 filed Dec. 28, 2023, which is incorporated herein in its entirety.

### TECHNICAL FIELD

The present disclosure generally relates to electronic devices that interpret hand or other user activity-based interactions with virtual elements in 3D environment such as extended reality (XR) environments.

### BACKGROUND

Existing user interaction systems may be improved with respect to facilitating interactions based on user activities.

### SUMMARY

Various implementations disclosed herein include devices, systems, and methods that interpret user activity as user interactions with virtual elements (e.g., user interface elements) positioned within in a 3D space such as an XR environment. Some implementations enable a user to provide input using a direct input modality in which the user interacts with virtual content by virtually touching the virtual content. As examples, a user may move their finger to directly tap, pinch, swipe, or otherwise interact with a user interface (UI) element within a 3D space.

Some implementations perform touch detection (e.g., detecting when a user's finger virtually makes, continues, and/or breaks virtual contact with a UI element in 3D space) using position and velocity information about the user. For example, this may involve using a z-velocity (e.g., velocity in a direction orthogonal/perpendicular to a surface of a user interface element) and/or a distance of a user portion (e.g., fingertip) from a surface in an XR environment to predict when the user portion will enter and when the user portion will exit the surface to determine the start and end of a touch interaction.

In one example, to determine the start of a touch, the device may determine if a fingertip of the user would push forward to touch a boundary (e.g., a surface of the element) a number x milliseconds in the future and, if so, it predicts a “make” touch event prior to the event being detected via sensor data analysis. The time value x may be based on system latency such that the prediction is made to enable the device to respond to touch makes when they actually occur, e.g., the predictions enable responses in a way that accounts for system latency. Using such a prediction may be limited to circumstances in which the user portion is relatively close to the virtual element surface, e.g., within a “fuzzy” zone, to assure accuracy and consistency with user intention.

Similarly, for example, to determine the end of a touch, the device may determine if the fingertip of the user would retract to exit through a boundary (e.g., a surface of the element) x milliseconds in the future and, if so, it predicts a “break” touch event prior to the event being detected via sensor data analysis. Similar to the make scenario, the time value x may be based on system latency such that the prediction is made to enable the device to respond to touch breaks when they actually occur, e.g., the predictions enable responses in a way that accounts for system latency. Using such a prediction may be limited to circumstances in which the user portion is relatively close to the surface, e.g., within a “fuzzy” zone, to assure accuracy and consistency with user intention. Some implementations utilize gesture estimation to dynamically adjust touch detection responsiveness based on interaction/gesture type. Some implementations provide interaction level touch interaction using criteria configured to enable determining if a touch is intentional and whether a touch should start or continue in various circumstances.

In some implementations, a processor performs a method by executing instructions stored on a computer readable medium. The method may involve displaying an XR environment corresponding to a 3D environment, where the XR environment depicts a portion of a user (e.g., the portion of the user may be a fingertip, hand, or other portion of the user) and a virtual element surface (e.g., a UI element surface). The method may involve determining a velocity (e.g., in the z direction orthogonal/perpendicular to the surface) of the portion of the user. The method may involve determining a position of the portion of the user relative to the virtual element surface in the XR environment. The method may involve predicting a start or an end of a touch interaction between the portion of the user and the virtual element surface based on the velocity of the portion of the user and the position of the portion of the user. The predicted start or end of the touch interactions may be used to facilitate a desirable user interaction experience, e.g., in which user interactions are responded to quickly than otherwise possible given system latency and/or user misperception.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment, in accordance with some implementations.

FIG. 2 illustrates views, provided via a device, of virtual elements within the 3D physical environment of FIG. 1 in which the user performs a direct interaction, in accordance with some implementations.

FIG. 3 illustrates an exemplary direct interaction, in accordance with some implementations.

FIGS. 4A-4B illustrate exemplary uses of make/break boundaries used for direct touch event detection, in accordance with some implementations.

FIG. 5A-5D illustrate exemplary circumstances in which touch detection may experience inaccuracies, in accordance with some implementations.

FIGS. 6A-6B illustrate additional exemplary circumstances in which touch detection may experience inaccuracies, in accordance with some implementations.

FIGS. 7A-7B illustrate exemplary determinations of direct touch make events based on velocity, in accordance with some implementations.

FIGS. 8A-8B illustrate an exemplary determinations of direct touch break events based on velocity, in accordance with some implementations.

FIG. 9 illustrates an exemplary direct touch detection pipeline, in accordance with some implementations.

FIG. 10 illustrates optimizing touch responsiveness for certain interactions that are sensitive to inaccuracy/latency while reducing risk of accidental breaks for interactions that are less sensitive to inaccuracy/latency, in accordance with some implementations.

FIG. 11 is a flowchart illustrating a method for interpreting user activity as a direct touch event, in accordance with some implementations.

FIG. 12 is a block diagram of an electronic device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

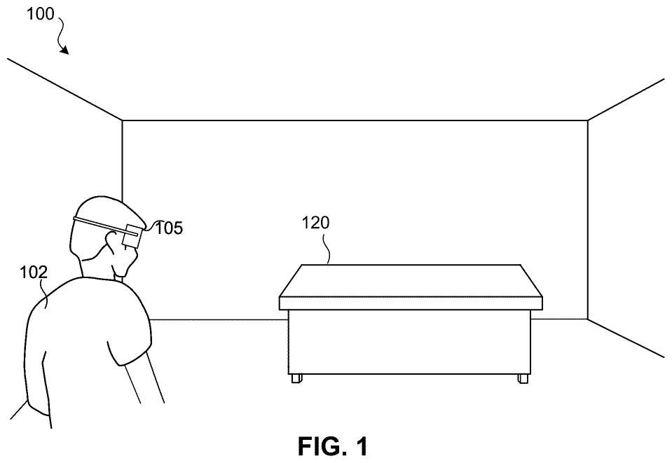

FIG. 1 illustrates an exemplary electronic device 105 operating in a physical environment 100. In the example of FIG. 1, the physical environment 100 is a room that includes a desk 120. The electronic device 105 may include one or more cameras, microphones, depth sensors, or other sensors that can be used to capture information (e.g., images, sound, lighting characteristics, etc.) about and evaluate the physical environment 100 and the objects within it, as well as information about the user 102 of electronic device 105. The information about the physical environment 100 and/or user 102 may be used to facilitate interactions, provide visual and audio content, and/or to identify the current location of the physical environment 100 (e.g., including locations of objects, such as the desk 120, in the physical environment 100) and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD, a handheld device such as a mobile device, a tablet computing device, a laptop computer, etc.). Such an XR environment may include views of a 3D environment that are generated based on camera images and/or depth camera images of the physical environment 100, as well as a representation of user 102 based on camera images and/or depth camera images of the user 102. Such an XR environment may include virtual content that is positioned at 3D locations relative to a 3D coordinate system (i.e., a 3D space) associated with the XR environment, which may correspond to a 3D coordinate system of the physical environment 100.

In some implementations, video (e.g., pass-through video depicting a physical environment) is received from an image sensor of a device (e.g., device 105). In some implementations, a 3D representation of a virtual environment is aligned with a 3D coordinate system of the physical environment. A sizing of the 3D representation of the virtual environment may be generated based on, for example, a scale of the physical environment or a positioning of an open space, floor, wall, etc., such that the 3D representation is configured to align with corresponding features of the physical environment. In some implementations, a viewpoint (e.g., of the user 102) within the 3D coordinate system may be determined based on a position of the electronic device within the physical environment. The viewpoint may be determined based on, for example, image data, depth sensor data, motion sensor data, etc., which may be retrieved via a virtual inertial odometry system (VIO), a simultaneous localization and mapping (SLAM) system, etc.

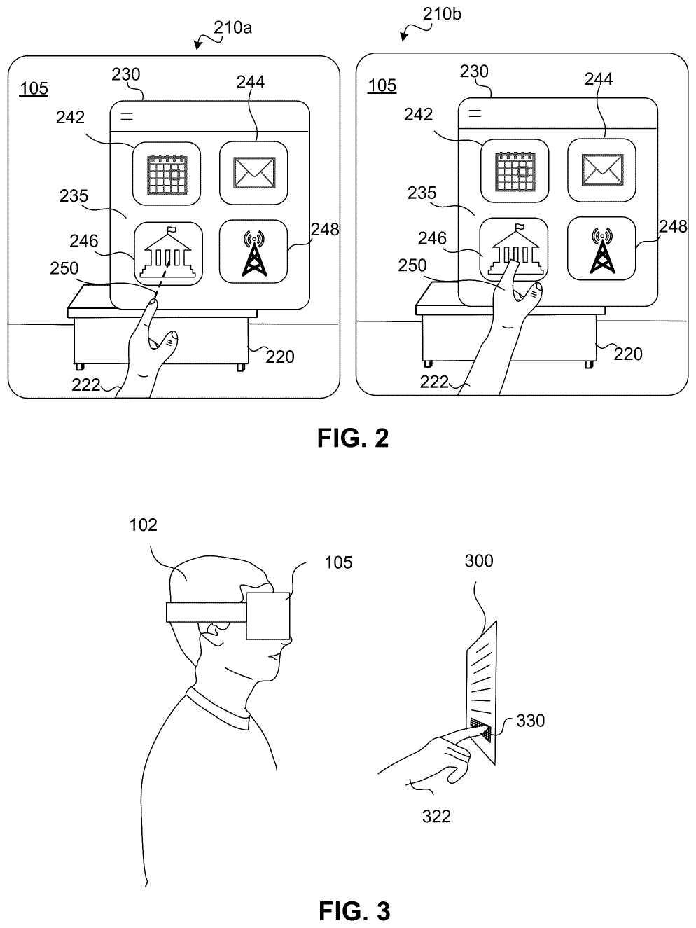

FIG. 2 illustrates views, provided via a device, of virtual elements within the 3D physical environment of FIG. 1 in which the user performs a direct interaction. This is one example of an XR environment view. In this example, the user 102 makes a hand gesture relative to content presented in views 210a-b of an XR environment provided by a device (e.g., device 105). The views 210a-b of the XR environment include an exemplary user interface 230 of an application (e.g., an example of virtual content) and a depiction 220 of the desk 120 (i.e., an example of real content). As an example, in FIG. 2, the user interface 230 is a two-dimensional virtual object (e.g., having a flat front-facing surface). Providing such a view may involve determining 3D attributes of the physical environment 100 above (e.g., a position of the desk 120 in the physical environment 100, a size of the desk 120, a size of the physical environment 100, etc.) and positioning the virtual content, e.g., user interface 230, in a 3D coordinate system corresponding to that physical environment 100.

In the example of FIG. 2, the user interface 230 includes various content items, including a background portion 235 and icons 242, 244, 246, 248. The icons 242, 244, 246, 248 may be displayed on the flat (or non-flat) user interface 230. The user interface 230 may be a user interface of an application, as illustrated in this example. The user interface 230 is simplified for purposes of illustration and user interfaces in practice may include any degree of complexity, any number of content items, and/or combinations of 2D and/or 3D content. The user interface 230 may be provided by operating systems and/or applications of various types including, but not limited to, messaging applications, web browser applications, content viewing applications, content creation and editing applications, or any other applications that can display, present, or otherwise use visual and/or audio content.

In this example, the background portion 235 of the user interface 230 is flat. In this example, the background portion 235 includes all aspects (e.g., visual characteristics) of the user interface 230 being displayed except for the icons 242, 244, 246, 248. Displaying a background portion of a user interface of an operating system or application as a flat surface may provide various advantages. For example, doing so may provide an easy to understand or otherwise use portion of an XR environment for accessing the user interface of the application. In some implementations, multiple user interfaces (e.g., corresponding to multiple, different applications) are presented sequentially and/or simultaneously within an XR environment using one or more flat background portions, though other configurations are possible.

In some implementations, the positions and/or orientations of such one or more user interfaces may be determined to facilitate visibility and/or use. The one or more user interfaces may be at fixed positions and orientations within the 3D environment. In such cases, user movements would not affect the position or orientation of the user interfaces within the 3D environment (e.g., such that the user interfaces remain at their respective positions or orientations and do not move relative to the viewpoint of the user).

The position of the user interface within the 3D environment may be based on determining a distance of the user interface from the user (e.g., from an initial or current user position). The position and/or distance from the user may be determined based on various criteria including, but not limited to, criteria that accounts for application type, application functionality, content type, content/text size, environment type, environment size, environment complexity, environment lighting, presence of others in the environment, use of the application or content by multiple users, user preferences, user input, and other factors.

In some implementations, the one or more user interfaces may be body-locked content, e.g., having a distance and orientation offset relative to a portion of the user's body (e.g., their torso). For example, the body-locked content of a user interface could be 0.5 meters away and 45 degrees to the left of the user's torso's forward-facing vector. If the user's head turns while the torso remains static, a body-locked user interface would appear to remain stationary in the 3D environment at 0.5 m away and 45 degrees to the left of the torso's front facing vector. However, if the user does rotate their torso (e.g., by spinning around in their chair), the body-locked user interface would follow the torso rotation and be repositioned within the 3D environment such that it is still 0.5 meters away and 45 degrees to the left of their torso's new forward-facing vector.

In other implementations, user interface content is defined at a specific distance from the user with the orientation relative to the user remaining static (e.g., if initially displayed in a cardinal direction, it will remain in that cardinal direction regardless of any head or body movement). In this example, the orientation of the body-locked content would not be referenced to any part of the user's body. In this different implementation, the body-locked user interface would not reposition itself in accordance with the torso rotation. For example, a body-locked user interface may be defined to be 2 m away and, based on the direction the user is currently facing, may be initially displayed north of the user. If the user rotates their torso 180 degrees to face south, the body-locked user interface would remain 2 m away to the north of the user, which is now directly behind the user.

A body-locked user interface could also be configured to always remain gravity or horizon aligned, such that head and/or body changes in the roll orientation would not cause the body-locked user interface to move within the 3D environment. Translational movement, on the other hand, would cause the body-locked content to be repositioned within the 3D environment in order to maintain the distance offset.

In the example of FIG. 2, the user 102 moves their hand from an initial position as illustrated by the position of the depiction 222 of the hand in view 210a. The hand moves along path 250 to a later position as illustrated by the position of the depiction 222 in the view 210b. As the user 102 moves their hand along this path 250, the finger intersects the user interface 230. Specifically, as the finger moves along the path 250, it virtually pierces the icon 246 in the user interface 230 and thus a tip portion of the finger (not shown) is optionally occluded in view 210b by the user interface 230 from the viewpoint of the user.

Implementations disclosed herein interpret user movements such as the user 102 of FIG. 1 moving their hand/finger along path 250 relative to a user interface element such as icon 246 in the user interface 230, to recognize user input/interactions. The interpretation of user movements and other user activity may be based on recognizing user intention using multiple, potentially separate, recognition processes corresponding to different input modalities. Using multiple, potentially separate, recognition processes for different modalities may improve functionality, accuracy, efficiency, and/or provide other device-based or interaction-based benefits.

Some implementations disclosed herein determine that a direct interaction mode is applicable and, based on the direct interaction mode, utilize a direct interaction recognition process to distinguish or otherwise interpret user activity that corresponds to direct input, e.g., identifying intended user interactions, for example, based on if, and how, a gesture path intersects one or more 3D regions of space. Such recognition processes may account for actual human tendencies associated with direct interactions (e.g., natural arcing that occurs during actions intended to be straight, tendency to make movements based on a shoulder or other pivot position (e.g., elbow), etc.), human perception issues (e.g., user's not seeing or knowing precisely where virtual content is located relative to their hand), and/or other direct interaction-specific issues.

Note that the user's movement in the real world (e.g., physical environment 100) correspond to movements within a 3D space, e.g., an XR environment that is based on the real-world and that includes virtual content such as user interface positioned relative to real-world objects including the user. Thus, the user is moving their hand in the physical environment 100, e.g., through empty space, but that hand (i.e., a depiction or representation of the hand) intersects with and/or pierces through the user interface 230 of the XR environment that is based on that physical environment. In this way, the user virtually interacts directly with the virtual content.

FIG. 3 illustrates an exemplary direct interaction. In this example, the user 102 is using device 105 (e.g., implemented as an HMD) to view and interact with an XR environment that includes the user interface 300. The user 102 moves their hand (depiction 322) to touch button 330 of the user interface 300 to make a selection that activates this button.

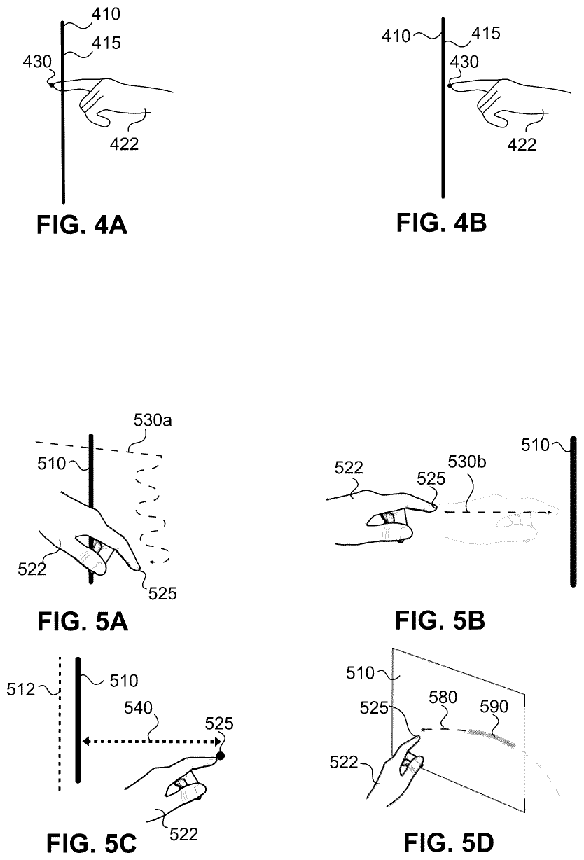

FIGS. 4A-4B illustrate exemplary direct touch detection based on distance from a user interface boundary (e.g., a make/break boundary). In the example of FIG. 4A, a surface 410 of a user interface is used as a make/break boundary 415. A make touch event is determined by tracking a position of fingertip 430 relative to the make boundary 415 of the surface 410, e.g., based on determining that the fingertip 430 position intersects or passes through the make/break boundary 415 of the surface 410, the device 105 determines that the user has made contact with the user interface-determining that a touch start has occurred. Such position tracking may be based on comparing the distance of the fingertip from a closest surface position on the make/break boundary. Similarly, when the user retracts his fingertip 430 and it exits from the make/break boundary 415, the device 105 determines that the user's contact with the user interface has ended-determining that a touch end has occurred. In various implementations, a make/brake boundary for a surface may be offset from the surface and the make boundary and break boundary may have different positions, for example, to account for system latency, e.g., latency in detecting fingertip position.

In contrast to FIG. 4A, in FIG. 4B, the user's fingertip 430 never intersects with the make/break boundary and thus no touch is detected, e.g., no make touch event is ever determined to have occurred. In this example, the user's fingertip 430 may have come close but not intersected the make/break boundary 415. Such failure to intersect may be contrary to a user's intention, e.g., the user may have intended to virtually touch the user interface but due to fingertip tracking inaccuracy, user perception issues, or for various other reasons, the intersection/distance requirement is not met and no touch may be detected.

FIG. 5A-5D illustrate exemplary circumstances in which touch detection may experience inaccuracies. In FIG. 5A, a user attempts to make multiple touches in a row (e.g., attempting to insert and remove fingertip 525 of hand 522 through surface 510 multiple times one after the other but does not sufficiently retract the fingertip 525 between each attempt to reinsert the fingertip 525). Thus, the path 530a of the fingertip only crosses the surface 510 a single time and only a single make touch event may be detected during the course of fingertip moving along path 530a.

In FIG. 5B, the user misses a touch as a result of never contacting the plane of the surface 510. Similar to the circumstances in FIG. 4B, in this example, the user's fingertip 525 travels along path 530b and may have come close to, but does not intersect, the make/break boundary 415. In this example, the missed touch (e.g., that was intended but not detected) may be due, as examples, to fingertip tracking inaccuracy, user misperception, or from various other causes.

In FIG. 5C, the user's intentions are inaccurately identified based on the user's hand 522 being behind the plane of the surface 510 (and make boundary 512 associated therewith). The user does not intend an interaction with surface 510. However, a make event is detected based on a literal finding of a position of hand 522 (e.g., its fingertip 525) being behind (e.g., having a negative z direction position relative to) the boundary 512. Such an error may be the result, for example, of rigid application of distance to boundary-based make/break rules.

In FIG. 5D, the user's intentions are again inaccurately identified based on the user's hand unintentionally leaving the plane of the user interface element 510 (in this case also the make/break boundary) during a portion of a swipe gesture that is intended to intersect with the plane of the user interface element 510 for longer/more distance than it actually does. In this example, the user's fingertip 525 travels along path 580 and exists through make/break boundary of the plane 510 of the user interface sooner than the user intended, e.g., during a long or large swipe. In this example, the inaccuracy (e.g., swipe duration being shorter than intended) may be due, as examples, to fingertip tracking inaccuracy, user misperception, or from various other causes.

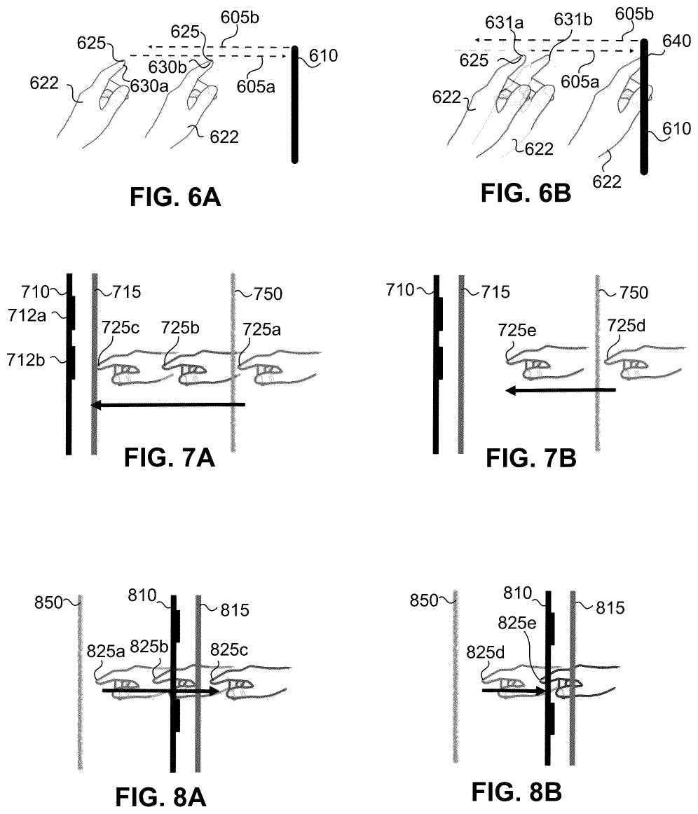

FIGS. 6A-6B illustrate additional exemplary circumstances in which certain touch detection methods may experience inaccuracies if not accounted for. In FIG. 6A, the user's hand 622 moves such that fingertip 625 moves along path 605a to intersect with user interface 610 and then retracts along path 605b (paths 605a and 605b may overlap but are shown separately for illustrative purposes). In this example, due to system latency (e.g., delay in determining hand/fingertip position), the user's actual fingertip 625 location is ahead of the detected fingertip 625 location. For example, when the user's fingertip is at location 630b, the system (due to system-latency) may be identifying location 630a as the fingertip's location. Some implementations disclosed herein account for such latency/delay, by predicting hand/fingertip location based on hand position and movement information, e.g., velocity towards or away from a boundary, plane, surface, etc.

FIG. 6B illustrates a system aligning touch detection timing with perceived touch timing (e.g., accounting for system delay/latency). In this example, the user's hand 622 again moves such that fingertip 625 moves along path 605a to intersect with user interface 610 and then retracts along path 605b. In this example, due to system latency (e.g., delay in determining hand/fingertip position), the user's actual fingertip 625 location is ahead of the detected fingertip 625 location. However, movement of the hand 622 (e.g., of the user's fingertip 625 from position 631a at a first point in time to 631b at a second point in time) is used to predict that the hand 622 (e.g., fingertip 625) will be at position 640 at a future point in time. This may involve determining a velocity, acceleration, or other movement characteristic of the hand 622 and/or fingertip 625 and using that movement characteristic to predict if and when the hand 622/fingertip 625 is expected to intersect the user interface 610, e.g., predicting, given the fingertip's current position and velocity, that it will intersect the user interface n millisecond in the future. This information may be used to trigger or detect a touch event (e.g., make touch event) in a way that accounts for or compensates for system latency. For example, a make touch event may be detected/triggered at a point when an expected fingertip-to-user interface intersection is projected to occur an amount of time in the future that is equal an expected system latency. Thus, if the system latency is expected to be 6 seconds and a finger-to-user-interface intersection is predicted to occur in 6 seconds, the system may trigger a touch make event now. Using such predictions (e.g., to detect make touch events even before sensed position information provides an intersection) can improve the responsiveness of a touch system, e.g., such that a user perceives user interface touch events being triggered immediately, e.g., when their finger actually to intersect a user interface and/or when the finger appears to the user to intersect the user interface.

FIGS. 7A-7B illustrate exemplary determinations of direct touch make events based on velocity and utilizing a fuzzy boundary 750. As with the example of FIG. 6B, movement information is used to predict an intersection that triggers a make touch event. In the example of FIG. 7A, the user's hand motion moves the fingertip from position 725a, through position 725b, and to position 725c over a period of time. In this example, a make boundary 715 is associated with the user interface 710 (which has buttons 712a-b ). The system is configured to use make touch event criteria to detect make touch events when the user's body portion (e.g., fingertip) is within the fuzzy boundary 750 (e.g., close enough to the make boundary 715) and has a velocity that is used to predict that a position of the portion of the user (e.g., user fingertip) will intersect with (or pass through) the make boundary 715 a predetermined amount of time, e.g., 0.5 seconds in the future. The fuzzy boundary 750 may be a predetermined distance away from (e.g., in front of a make boundary 715). In this example (of FIG. 7A), when the fingertip position 725b is detected, the fingertip is predicted to have a velocity such that its predicted position in the future (e.g., 0.5 seconds in the future) is at position 725c where it intersects with the make boundary 715. Having satisfied the make detection event criteria, the system predicts a touch with the user interface 710. In this example, based on the predicted position 725c, the touch is determined to be a touch for button 712b of the user interface, e.g., based on the predicted x/y position (i.e., of position 725c) of the touch on the make boundary 715 corresponding to an x/y position on the user interface 710 that corresponds to the button 712b.

Various implementations account for the timing of touch input, e.g., a make touch event. For example, the system may predict when a future touch will occur and trigger touch input events at that time. In some implementations, predicting that a touch will occur at a point in time the future (e.g., x milliseconds in the future) enables the system to be more responsive than it otherwise could be given system resource constraints, lags, detection time, etc. For example, if it takes y milliseconds to predict that a touch is about to occur x milliseconds in the future and x equals y, then the system is able to trigger a touch input at the same instant that the touch actually occurs by triggering the touch as soon as it is predicted. In another example, if it takes y milliseconds to predict that a touch is about to occur x milliseconds in the future and x is greater than y, then the system is able to trigger a touch input at the same instant that the touch actually occurs by waiting (e.g., z milliseconds (e.g., x-y milliseconds) before triggering the touch event after the touch is predicted. During any such a waiting period between predicting a touch and triggering a corresponding touch input event, the system may continue to track to confirm (e.g., adjusting confidence) that the touch will occur as predicted. If the finger stops, retracts, etc. the prior prediction may be disregarded and no touch event initiated. In some implementations, the system waits to see when the user's finger stops or stops and retracts (regardless of where it is when stopped) and then uses that movement to initiate an input. The system may use prediction, tracking, and adjustments to provide intuitive feel for successful tapping input. The use of prediction may enable intended touches, taps, etc. to be predicted more quickly and/or even if the user's finger does not actually touch/pierce the user interface element surface. Using prediction to more precisely time make (and break) touch events may also enable the system to better distinguish between touches that depend upon timing (e.g., between taps, long presses, etc.). It may also enable a user to intentionally discontinue a tap, e.g., by touching down and then avoiding a break event, for example, by moving the finger slowly off to the side instead of retracting through the user interface element surface.

In some implementations, the system accounts for a circumstance in which the predicted location of the finger never intersects with the UI plane but the finger does cross a fuzzy boundary (e.g., a slow tap in which the user intends a tap but moves their finger too slowly and not deep enough). The finger may actually cross the boundary stop and retract without intersecting the UI plane because the user misjudged the depth, as an example. The system may be able to detect this activity as an intended touch using various criteria and using the location where the user's finger stops and retracts to identify an intended UI element surface intersection location. Various types of movements may be identified (e.g., approach, stop, retract, etc.) within the fuzzy boundary and determined to be an intentional intersection and thus, for example, result in a successful tap. The location of such a tap may be a location of the UI that intersects with the directional axis of movement of the finger when approaching the UI (which can be non-orthogonal to the UI plane).

In the example of FIG. 7B, the user's hand motion again moves the fingertip. In this example, the make boundary 715 is associated with the user interface 710 (which has buttons 712a-b). The system is configured to use make touch event criteria to detect make touch events when the user's body portion (e.g., fingertip) is within the fuzzy boundary 750 (e.g., close enough to the make boundary 715) and has a velocity such that a predicted position of the portion of the user (e.g., user fingertip) will intersect with (or pass through) the make boundary 715 a predetermined amount of time, e.g., 0.5 seconds in the future. In this example, when the fingertip position 725d is detected, the fingertip is predicted to have a velocity such that its predicted position in the future (e.g., 0.5 seconds in the future) is at position 725e where it does not yet intersect with the make boundary 715. Moreover, the position 725d of the fingertip is not yet detected within the fuzzy boundary 750. Having not yet satisfied the make detection event criteria, the system does not yet predict a touch with the user interface 710.

FIGS. 8A-8B illustrate exemplary determinations of direct touch break events based on velocity and utilizing a fuzzy boundary 850. Movement information is used to predict an exit event that triggers a break touch event. In the example of FIG. 8A, the user's hand portion (e.g., fingertip) has already been determined to touch user interface 810 (e.g., a make touch event has already been detected) and the user's continuing hand motion moves the fingertip from position 825a, through position 825b, and to position 825c over a period of time. In this example, a break boundary 815 is associated with the user interface 810. The system is configured to use break touch event criteria to detect break touch events when the user's body portion (e.g., fingertip) is within the fuzzy boundary 850 (e.g., close enough to the break boundary 815) and has a velocity that is used to predict that a position of the portion of the user (e.g., user fingertip) will intersect with (or exit from) the break boundary 815 a predetermined amount of time, e.g., 0.5 seconds in the future. The fuzzy boundary 850 may be positioned relative to the user interface 810 and/or the break boundary 815 (e.g., UI 810 positioned between the break boundary 815 and the fuzzy boundary 850) with the user (e.g., the user's head, torso, etc.,) generally being outside of the break boundary 815 (to the right in FIG. 8A). In this example (of FIG. 8A), when the fingertip position 825b is detected, the fingertip is predicted to have a velocity such that its predicted position in the future (e.g., 0.5 seconds in the future) is at position 825c where it intersects with the break boundary 815. Having satisfied the break detection event criteria, the system predicts an end of touch with the user interface 810.

Various implementations account for the timing of touch input, e.g., a break touch event. For example, the system may predict when a future break will occur and a break event at that time. In some implementations, predicting that a break will occur at a point in time the future (e.g., x milliseconds in the future) enables the system to be more responsive than it otherwise could be given system resource constraints, lags, detection time, etc. For example, if it takes y milliseconds to predict that a break is about to occur x milliseconds in the future and x equals y, then the system is able to trigger a break at the same instant that the break actually occurs by triggering the break as soon as it is predicted. In another example, if it takes y milliseconds to predict that a break is about to occur x milliseconds in the future and x is greater than y, then the system is able to trigger a break at the same instant that the break actually occurs by waiting (e.g., z milliseconds (e.g., x-y milliseconds) before triggering the break after the break is predicted. During any such a waiting period between predicting a break and triggering a corresponding break event, the system may continue to track to confirm (e.g., adjusting confidence) that the break will occur as predicted.

Some implementations predicting make and/or break events facilitates the identification of intended successive taps, e.g., one tap after another, as opposed to one long tap (e.g., in the circumstance of FIG. 5). This may involve using position, velocity, and/or acceleration information to predict finger motion and timing of events, which may be used to predict or identify one or more intended actions (e.g., make, break, thrust, retraction, etc.), which may then be used to distinguish between successive taps, a long press, and/or other user interactions. In one example, the velocity of finger pull-back at a given time is great enough such that that system identifies an intended exit/break even if one does not occur (e.g., during the middle of the motion illustrated in FIG. 5A). Similarly, a sequency of motions having certain characteristics, e.g., a finger moving back at a more than a threshold velocity then moving forward at more than a threshold velocity may be used to identify an intended multiple tap interaction versus one lone interaction even when the finger does not retract all the way back through the UI plane.

In the example of FIG. 8B, the user's hand portion (e.g., fingertip) has already been determined to touch user interface 810 (e.g., a make touch event has already been detected) and the user's hand motion continues to move the fingertip. In this example, the make boundary 815 is associated with the user interface 810. The system is configured to use break touch event criteria to detect break touch events when the user's body portion (e.g., fingertip) is within the fuzzy boundary 850 (e.g., close enough to the make boundary 815) and has a velocity that is used to predict that a position of the portion of the user (e.g., user fingertip) will intersect with (or exit from) the break boundary 815 a predetermined amount of time, e.g., 0.5 seconds in the future. In this example, when the fingertip position 825d is detected, the fingertip is predicted to have a velocity such that its predicted position in the future (e.g., 0.5 seconds in the future) is at position 825e where it does not yet intersect with (or has not yet exited from) the break boundary 815. Having not yet satisfied the break detection event criteria, the system does not yet predict an end to the touch with the user interface 710, i.e., the touch continues.

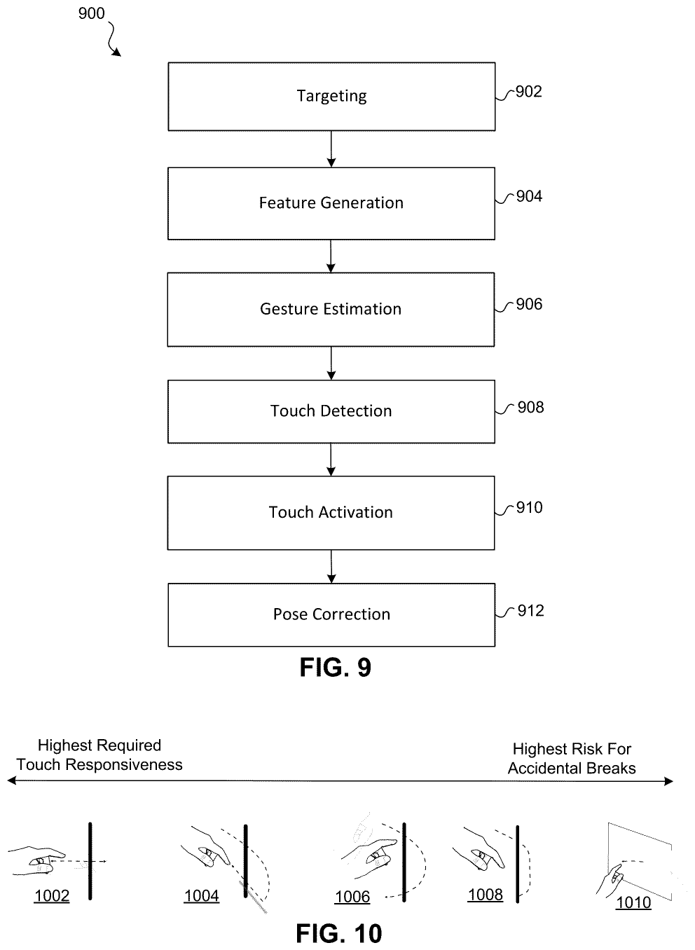

FIG. 9 illustrates an exemplary direct touch detection pipeline 900. In this pipeline, a targeting step 902 is responsible for selecting an optional target (e.g., UI element) based on user activity, e.g., where the user's body portion (e.g., fingertip, etc.) is, where the user is looking, what possible UI elements or other content is nearby and/or its interaction characteristics, etc. The targeting step 902 may output a target and relevant properties. The feature generation step 904 is responsible for computing various features of the body portion (e.g., fingertip) with respect to the target. The feature generation step 904 may output signals and higher-level features of the body portion. The gesture estimation step 906 predicts a gesture that the user activity involves, e.g., tap, swipe, scroll, etc. The gesture estimation step 906 may be implemented as a gesture state machine. The gesture estimation step 906 may output an estimated gesture. The touch detection step 908 is responsible for identifying touch and/or touch-related actions (e.g., hover). The touch detection step 908 may output a touch, touch events, hover, hover events, etc. The touch activation step 910 is responsible for activating intentional touches. The touch activation step 910 may output a touch active state, a hover active state, etc. The pose correction step 912 is responsible for correcting a pose (e.g., position) of a touch during an active touch. The pose correction step 912 may output a corrected interaction pose identifying where on a user interface or other virtual content a touch occurs.

FIG. 10 illustrates optimizing touch responsiveness for interactions that need it while reducing risk of accidental breaks for interactions that are less sensitive to inaccuracy. Some implementations leverage hand-target features to estimate a gesture (e.g., from the gesture estimation step of FIG. 9) and dynamically adjust make/break sensitivity accordingly. In FIG. 10, different events of different interaction types are shown along a gesture-responsiveness scale/map. Specifically, a tap/long press interaction type 1002, a drag end 1004, a 1D swipe 1006, a 1D drag 1008, and 2D pan (e.g., drawing) 1010 are illustrated going from interaction types requiring the most touch responsiveness to interaction types most at risk for accidental breaks (e.g., when an intended continuous interaction/touch is interrupted by a false break). Events of interaction types requiring most touch responsiveness may require the most touch sensitivity and thus may use the longest (e.g., into the future) prediction of hand position (e.g., predicting position x seconds into the future based on velocity where x is based on latency or otherwise a max value, etc.). Conversely, events of interaction types requiring less responsiveness or otherwise better suited for reducing responsiveness to improve unintended occurrences such as accidental break may have less or no touch sensitivity, and thus may have the less touch responsiveness using shorter (e.g., into the future) predictions (or no predictions) of hand position.

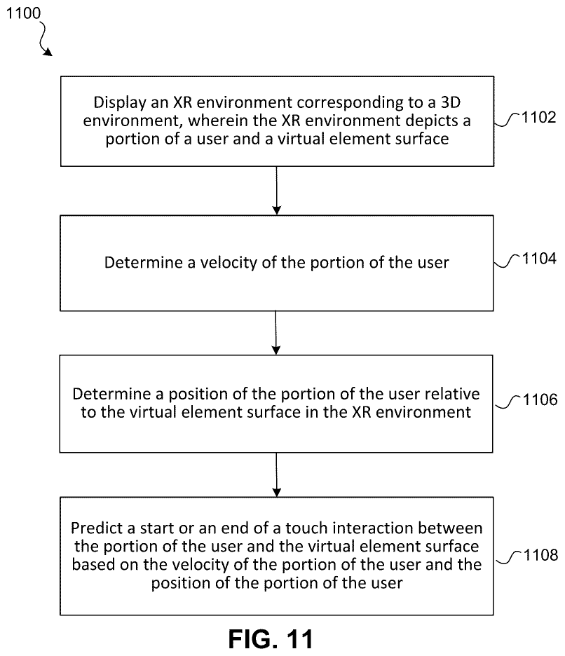

FIG. 11 is a flowchart illustrating a method 1100 for interpreting user activity as a direct touch event. In some implementations, a device such as electronic device 105 performs method 1100. In some implementations, method 1100 is performed on a mobile device, desktop, laptop, HMD, or server device. The method 1100 is performed by processing logic, including hardware, firmware, software, or a combination thereof. In some implementations, the method 1100 is performed on a processor executing code stored in a non-transitory computer-readable medium (e.g., a memory).

At block 1102, the method 1400 includes displaying an XR environment corresponding to a 3D space, where the XR environment depicts a portion of a user and a virtual element surface. The virtual object may be a user interface element such as a button, icon, text entry field, slider bar, or menu item, etc., that is presented as part of a virtual UI displayed at a fixed position or otherwise within the XR environment, e.g., a virtual 2D menu with buttons displayed a few feet in front of the user in XR.

At block 1104, the method 1100 includes determining a velocity of the portion of the user. The velocity may be a velocity in a particular direction (e.g., the z-direction component of the total velocity where the z-direction, for example, is a direction orthogonal to/perpendicular to the virtual element surface. Determining the velocity may involve obtaining user position data corresponding to a 3D position of a portion (e.g., fingertip/hand) of a user in the 3D space. The user position data may be obtained based on sensor data (e.g., image sensor, depth sensor data, motion sensor data, etc.) and may provide a path of the portion of the user over a time period. In one example, the user position data may be a skeleton representation of the user generated periodically, e.g., 30 fps, based on outward facing image/depth sensors on an HMD. Such user position data may provide a path of a portion of the skeleton (e.g., a finger skeleton portion). In other words, for example, by tracking the orientation of the skeleton over multiple instants in time, a path of a finger portion of the skeleton over time relative to a 3D space may be determined.

In some implementations, the portion of the user corresponds to a point on or in a finger of the user. The portion of the user may correspond to a point on or in a hand of the user. The user position data may correspond to a position within a skeleton representation of the user that is generated periodically, e.g., at multiple points in time during a period of time.

At block 1106, the method 1100 includes determining a position of the portion of the user relative to the virtual element surface in the XR environment. This may involve determining whether the position of the portion of the user (e.g., the user's fingertip) is within a fuzzy region (as illustrated in FIGS. 7A, 7B, 8A, 8B).

At block 1108, the method 1100 includes predicting a start or an end of a touch interaction between the portion of the user and the virtual element surface based on the velocity of the portion of the user and the position of the portion of the user.

A start of a touch interaction may be detected based on predicting a path of the portion of the user will intersect the virtual element surface at a future time. The start of the touch interaction may be identified based on the predicting and a system latency. The start of the touch interaction may be identified based on the position of the portion of the user being within a region (e.g., within a predetermined distance of the surface/make fuzzy region).

In the case of a predicting a start of a touch interaction, make detection criteria may be applied. As illustrated in FIGS. 7A-7B, the method 1100 may use make touch event criteria to detect make touch events when the user's body portion (e.g., fingertip) is within a fuzzy boundary (e.g., close enough to the make boundary) and has a velocity that predicts a position of the portion of the user (e.g., user fingertip) that intersects with (or has passed through) a make boundary a predetermined amount of time, e.g., 0.5 seconds in the future.

An end of the touch interaction is detected based on predicting a path of the portion of the user will exit the virtual element surface at a future time. The end of the touch interaction may be identified based on the predicting and a system latency. The end of the touch interaction is identified based on the position of the portion of the user being within a region (e.g., within a predetermined distance of the surface/break fuzzy region).

In the case predicting the end of a touch interaction, break detection criteria may be applied. As illustrated in FIGS. 8A-8B, the method 1100 may use break touch event criteria to detect break touch events when the user's body portion (e.g., fingertip) is within a fuzzy boundary (e.g., close enough to the make boundary 815) and has a velocity that predicts a position of the portion of the user (e.g., user fingertip) that intersects with (or has exited from) a break boundary 815 a predetermined amount of time, e.g., 0.5 seconds in the future.

Some implementations, use gesture estimation to dynamically adjust touch detection responsiveness based on interaction/gesture type, as illustrated in FIG. 10. In some implementations, predicting the start or the end of the touch interaction is based on: predicting a path of the portion of the user will intersect or exit the virtual element surface at a future time; and determining the start or the end of the touch interaction based on whether the future time is less than a time threshold, wherein the time threshold depends upon a sensitivity setting (e.g., make/break sensitivity). The sensitivity setting may be determined based on estimating a type of movement (e.g., gesture type) of the portion of the user. The sensitivity setting may be determined based on output of a state machine identifying a gesture type of tap, swipe, drag, pan, etc.

Some implementations determine whether a touch is intentional and/or whether a touch should start or continue using various criteria to provide a desirable user experience. Some implementations only allow a touch to be activated if user intent to touch is detect. This may involve utilizing higher-level rules to determine, for example, when to prevent the start of a new touch or end an ongoing touch. In one example, predicting the start of the touch interaction is based on whether the portion of the user is outside of a region in front of the virtual element surface, a boundary of the region determined corresponding to a boundary of the virtual element surface. For example, if the user's hand is off the left side of the user interface's side boundary then no touch may be activated. In another example in which the portion of the user is a portion of a finger (e.g., fingertip), predicting the start of the touch interaction is based on whether a hand of the user intersects the virtual element surface. Thus, if the user's hand is far past the user interface element surface such that none of the hand intersects the element (e.g., where the user is interacting with or intending to interact with something beyond the virtual element rather than the virtual element), then a touch may not be activated. In another example, predicting the start of the touch interaction is based on determining whether a pinch (e.g., a gesture indicative of another type of interaction) was released within a region associated with the virtual element surface. This may involve preventing the starting of a touch if a direct pinch was released within the surface of the virtual element, e.g., where the user is concluding another gesture rather than intending to interact with the virtual element surface via a new touch gesture.

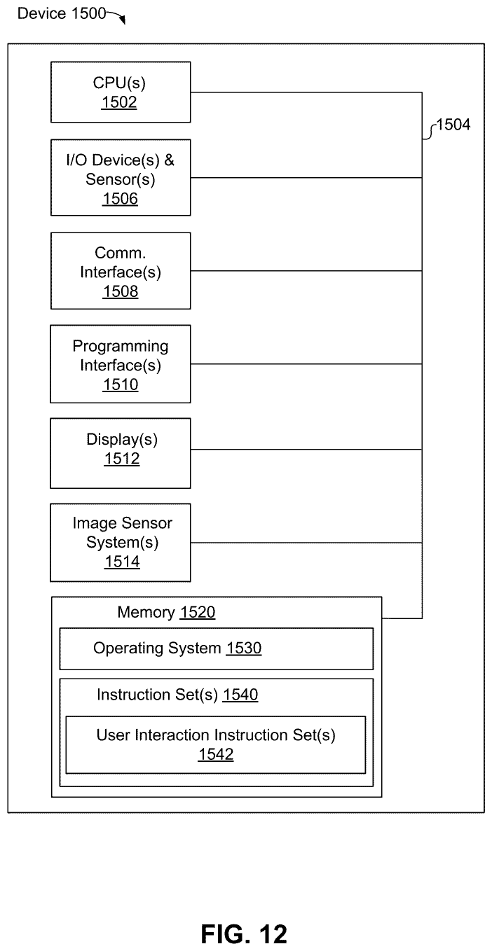

FIG. 12 is a block diagram of electronic device 1500. Device 1500 illustrates an exemplary device configuration for electronic device 105. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1500 includes one or more processing units 1502 (e.g., microprocessors, ASICs, FPGAs, GPUs, CPUs, processing cores, and/or the like), one or more input/output (I/O) devices and sensors 1506, one or more communication interfaces 1508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1510, one or more output device(s) 1512 (e.g., including displays), one or more interior and/or exterior facing image sensor systems 1514, a memory 1520, and one or more communication buses 1504 for interconnecting these and various other components.

In some implementations, the one or more communication buses 1504 include circuitry that interconnects and controls communications between system components. In some implementations, the one or more I/O devices and sensors 1506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1512 include one or more displays configured to present a view of a 3D environment to the user. In some implementations, the one or more displays correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1500 includes a single display. In another example, the device 1500 includes a display for each eye of the user.

In some implementations, the one or more output device(s) 1512 include one or more audio producing devices. In some implementations, the one or more output device(s) 1512 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1512 may additionally or alternatively be configured to generate haptics.

In some implementations, the one or more image sensor systems 1514 are configured to obtain image data that corresponds to at least a portion of a physical environment. For example, the one or more image sensor systems 1514 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1514 further include illumination sources that emit light, such as a flash. In various implementations, the one or more image sensor systems 1514 further include an on-camera image signal processor (ISP) configured to execute a plurality of processing operations on the image data.

The memory 1520 includes high-speed random-access memory, such as DRAM, SRAM, DDR RAM, or other random-access solid-state memory devices. In some implementations, the memory 1520 includes non-volatile memory, such as one or more magnetic disk storage devices, optical disk storage devices, flash memory devices, or other non-volatile solid-state storage devices. The memory 1520 optionally includes one or more storage devices remotely located from the one or more processing units 1502. The memory 1520 comprises a non-transitory computer readable storage medium.

In some implementations, the memory 1520 or the non-transitory computer readable storage medium of the memory 1520 stores an optional operating system 1530 and one or more instruction set(s) 1540. The operating system 1530 includes procedures for handling various basic system services and for performing hardware dependent tasks. In some implementations, the instruction set(s) 1540 include executable software defined by binary information stored in the form of electrical charge. In some implementations, the instruction set(s) 1540 are software that is executable by the one or more processing units 1502 to carry out one or more of the techniques described herein.

The instruction set(s) 1540 include user interaction instruction set(s) 1542 configured to, upon execution, identify and/or interpret user gestures and other activities as described herein. The instruction set(s) 1540 may be embodied as a single software executable or multiple software executables.

Although the instruction set(s) 1540 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device having a processor:
displaying an extended reality (XR) environment corresponding to a three-dimensional (3D) environment, wherein the XR environment depicts a portion of a user and a virtual element surface;
determining a velocity of the portion of the user;
determining a position of the portion of the user relative to the virtual element surface in the XR environment; and
predicting a start or an end of a touch interaction between the portion of the user and the virtual element surface based on the velocity of the portion of the user and the position of the portion of the user.

2. The method of claim 1, wherein the velocity is a velocity in direction perpendicular to the virtual element surface.

3. The method of claim 1, wherein the start of the touch interaction is detected.

4. The method of claim 1, wherein the start of the touch interaction is detected based on predicting a path of the portion of the user will intersect the virtual element surface at a future time.

5. The method of claim 4, wherein the start of the touch interaction is identified based on the predicting and a system latency.

6. The method of claim 4, wherein the start of the touch interaction is identified based on the position of the portion of the user being within a region.

7. The method of claim 1, wherein the end of the touch interaction is detected.

8. The method of claim 1, wherein the end of the touch interaction is detected based on predicting a path of the portion of the user will exit the virtual element surface at a future time.

9. The method of claim 8, wherein the end of the touch interaction is identified based on the predicting and a system latency.

10. The method of claim 8, wherein the end of the touch interaction is identified based on the position of the portion of the user being within a region.

11. The method of claim 1, wherein predicting the start or the end of the touch interaction is based on:
predicting a path of the portion of the user will intersect or exit the virtual element surface at a future time; and
determining the start or the end of the touch interaction based on whether the future time is less than a time threshold, wherein the time threshold depends upon a sensitivity setting.

12. The method of claim 11, wherein the sensitivity setting is determined based on estimating a type of movement of the portion of the user.

13. The method of claim 12, wherein the sensitivity setting is determined based on output of a state machine identifying a gesture type of tap, swipe, drag, or pan.

14. The method of claim 1, wherein predicting the start of the touch interaction is based on whether the portion of the user is outside of a region in front of the virtual element surface, a boundary of the region determined corresponding to a boundary of the virtual element surface.

15. The method of claim 1, wherein the portion of the user is a portion of a finger and predicting the start of the touch interaction is based on whether a hand of the user intersects the virtual element surface.

16. The method of claim 1, wherein predicting the start of the touch interaction is based on determining whether a pinch was released within a region associated with the virtual element surface.

17. The method of claim 1, wherein the portion of the user is a fingertip.

18. The method of claim 1, wherein the electronic device is a head-mounted device.

19. A system comprising:
memory; and
one or more processors coupled to the memory, wherein the memory comprises program instructions that, when executed by the one or more processors, cause the system to perform operations comprising:
displaying an extended reality (XR) environment corresponding to a three-dimensional (3D) environment, wherein the XR environment depicts a portion of a user and a virtual element surface;
determining a velocity of the portion of the user;
determining a position of the portion of the user relative to the virtual element surface in the XR environment; and
predicting a start or an end of a touch interaction between the portion of the user and the virtual element surface based on the velocity of the portion of the user and the position of the portion of the user.

20. A non-transitory computer-readable storage medium, storing program instructions executable by one or more processors to perform operations comprising:
displaying an extended reality (XR) environment corresponding to a three-dimensional (3D) environment, wherein the XR environment depicts a portion of a user and a virtual element surface;
determining a velocity of the portion of the user;
determining a position of the portion of the user relative to the virtual element surface in the XR environment; and
predicting a start or an end of a touch interaction between the portion of the user and the virtual element surface based on the velocity of the portion of the user and the position of the portion of the user.
